(19) United States
(12) Patent Application Publication
(10) Pub. No.: US 2023/0320926 A1
(43) Pub. Date: Oct. 12, 2023

(54) HANDHELD SELF-ADMINISTERED MASSAGE DEVICE

(71) Applicant: Jeffrey Burk, Lancaster, CA (US)

(72) Inventor: Jeffrey Burk, Lancaster, CA (US)

(21) Appl. No.: 18/297,486

(22) Filed: Apr. 7, 2023

Related U.S. Application Data
(60) Provisional application No. 63/329,212, filed on Apr. 8, 2022.

(51) Int. Cl. A61H 15/00

(52) U.S. Cl. CPC A61H 15/0092

(57) ABSTRACT

The present invention discloses an improved handheld self-administered massage device which can be targeted on an aimed human body site in a symmetrical way with a sufficient pressure to provide an efficacious self-massage. The handheld self-administered massage device herein comprises a pair of massage balls encased within a stretchable fabric strap and/or an elastic band, wherein the stretchable fabric strap and/or the elastic band includes a holding means at both ends to be held by a user. The main purpose of the present invention is to facilitate a targeted control and pressure which is ascertained by the user based on the massaging requirements thereby to soothe or eliminate body aches and muscle tension, or simply to relax and refresh.

### CROSS-REFERENCE TO RELATED APPLICATIONS

This application claims the benefit of U.S. Provisional Application No. 63/329,212, titled “HANDHELD SELF-ADMINISTERED MASSAGE DEVICE” and filed on 2022 Apr. 8, the content of which is expressly incorporated herein by reference in its entirety. which is incorporated herein by reference.

### FIELD OF THE INVENTION

The present invention relates primarily to a massage device, and more particularly it relates to a simple yet unique, improved handheld self-administered massage device which includes a pair of massage balls affixed within a stretchable fabric strap and/or an elastic band, designed specifically to allow a user to provide themself with a targeted self-massage, thereby to soothe or eliminate muscle tension and pain, or simply to relax and refresh.

### BACKGROUND OF THE INVENTION

A task of massaging has been known since decades which aids to relieve body aches, provides therapeutic effects, and imparts a soothing effect on the person being massaged. Generally, massagers use their bare hands when giving a massage. Also, the massagers use aiding implements such as electric vibrators, rolling pins, pebbles and balls etc. to amplify the beneficial effect of the massage. Most of these implements are unmanageable and are easily misplaced and limited in their functionality because of bulkiness and awkwardness in holding and maintaining the implement in a desired body location.

Over the course of time, various devices have been invented to self-administer a massaging action to one's back as a remedial procedure addressing various ailments. Moreover, various prior arts have been disclosed in order to attempt and solve the aforesaid problem as this is a crowded field. A prior art U.S. Pat. No. 5,577,996A to Gary R. Gardne, discloses a handheld massage device having a plurality of spheres mounted on an axial rod with enlarged grip handles mounted on the outer ends of the rod for rotation. The spheres may be adjusted to various positions along the axis of the rod to comfort and to direct the massage to specific areas. The axial rod used is similar to dowel. The spheres are hollow, resilient spheres such as tennis balls. However, the Gary implements the dowel type axial rod of fixed length which cannot be extended or elongated to increase or decrease the distance between the massage spheres. Also, such roller type massage device is not facilitated to allow multiple handle grip designs. The inflexibility of this massage device therefore results in discomfort, and thereby fails to impart the expected therapeutic effects in a symmetrical way and with sufficient pressure.

A prior art US20140114221A1 to Kathy L. Indermill et al., describes a handheld roller massage apparatus which comprises two air-filled elastomeric massage spheres, two handle grips attached to a rigid cylindrical metal tube where the handle grips and massage spheres are fully adjustable along the rigid cylindrical metal tube, four T-washers, and two end caps. The massage spheres are hollow balls with 2.5-3 inches in outer diameter made of elastomeric or resilient material that deflects or deforms under pressure but returns to its original shape when the pressure is released. However, the Kathy implements the rigid cylindrical metal tube of fixed length which cannot be extended or elongated as required by a person. As a matter of fact, the limitations of the abovementioned invention of the Gary have not been overcame by the invention of the Kathy. This further inflexibility hereby leads only to discomfort and unsatisfied therapeutic effects to the person being massaged.

Another prior art U.S. Pat. No. 7,087,004B1 to Michael N. Berke, describes a massaging device which is straddled over the doorstop of a door opening at an elevated location coincident with a hard-to-reach back area and held in place by the leaning weight of a user moving back and forth and up and down permitting a self-administered back massage. The device of Michael needs to be installed over some structure in order to carry out massaging activity.

Another prior art U.S. Pat. No. 6,758,826B2 to Harold A. Luettgen et al., discloses a J-shaped vibrating massager which comprises a J-shaped tubular rod, a head, one or more handles, vibratory sources, and vibratory controls. The vibratory source induces vibrations in one or more portions of the J-shaped tubular rod. Because the massager is generally J-shaped, a user may reach his or her own back with the head of the J-shaped massager in order to give himself a back massage.

Another prior art U.S. Pat. No. 9,999,563B2 to Walter David Bond, introduces a massage device configured to apply pressure to a human user's back, shoulders, or any distinct part of the musculoskeletal system. The massage device includes an arm plate configured to cover a forearm and a wrist of a human user, a hand grip mechanically coupled to the arm plate and configured to accommodate the gripping of human fingers, a wrist bar attached to the arm plate, a J-bar may be attached to the wrist bar, and a tip attached to the J-bar or directly to the short wrist bar. The tip is configured to provide variant pressure to the human user's back or shoulders or distal body part.

Another prior art U.S. Pat. No. 9,532,918B1 to John G Louis et al., discloses a handheld massage device employed to provide therapeutic massage to a user's backside includes a user-grippable, generally hook-shaped handle and a massage tool mounted at one end. The massage tool has a plurality of body-contacting work elements that may be selectively moved into operative position and locked in place. A releasable, spring-loaded locking mechanism is provided between the handle and the massage tool so that the tool is locked in position when engaged and unlocked and rotatable when disengaged.

Another prior art U.S. Pat. No. 6,988,997B2 to Michael O. Stultz, describes an exercise and massage apparatus which has a pair of elongate handles, where each of the handles provides a curved distal end and a plurality of interchangeable massage heads. Each of the massage heads includes a massage plate supporting plural massage fingers. A releasable engagement means enables the plates to be mutually secured and released so the handles are able to control the massage fingers with the massage fingers forming an acute angle with the handles whereby the massage fingers are positionable in contact with a user's back with the handles manipulated from over the user's shoulders.

Although there is a plurality of self-administered massage devices available in the market in order to allow the person to provide themself with a targeted self-massage, they do not adequately solve or render a viable solution to the current problem. Based on the prior arts research as described above, the vast majority of the massage devices are relatively short, more precisely a foot in length or less. Also, some devices are relatively linear, with one end operating as a massage head and the other as a handle or gripping means. Because of the overall length and shape of conventional personal massage devices, it is extremely difficult for the person to massage his or her own back. To a certain extent, the person may need to take help of other person, which substantially limits the utility of the most conventional massage devices. Moreover, the roller style self-massage devices which are available commercially have been failed to provide an effective self-massage.

The applicant is unaware of any such massage devices which can be targeted in the symmetrical way and with the sufficient pressure to provide the effective self-massage. More specifically, there is no such handheld self-administered massage device known in the prior arts that has a flexible design in order to provide a targeted control and symmetry that cannot be achieved with the massage balls alone, and a targeted pressure that cannot be achieved by the traditional roller style self-massage products.

The conventional self-massage devices encounter various problems and are provided with quite an inflexible configuration. On the other hand, the present invention discloses a practical solution via an improved handheld self-administered massage device which comprises a pair of massage balls attached within a stretchable fabric strap and/or an elastic band that can be stretched and released to increase or decrease the distance between the massage balls, hence to allow the person to provide themself with a targeted self-massage. The unique characteristics and features of the present invention are, therefore, unrepresented within the conventional self-massaging devices. Hence, the present invention has been disclosed to provide solutions to the aforementioned needs, and to resolve the aforementioned deficiencies in the conventional self-massaging methods and apparatuses.

### SUMMARY OF THE INVENTION

The present invention concerns improvements in and relating to handheld self-administered massage device that can be targeted on an intended massaging site in a symmetrical way and with a sufficient pressure to provide an effective self-massage, wherein the handheld self-administered massage device comprises a pair of massage balls encased within a stretchable fabric strap and/or an elastic band, wherein the stretchable fabric strap and/or the elastic band includes a holding means at both ends to be comfortably held by a user. The handheld self-administered massage device is placed between the user's back and a wall or floor while the user is holding each end of the stretchable fabric strap in each hand. The handheld self-administered massage device utilizes the user's body weight while the user leans with their back against the wall or floor to provide pressure for the self-massage, wherein the user can vary the pressure by angling their body against the wall in different ways and pushing against the floor with their feet. The handheld self-administered massage device can be implemented on other areas of the body in a similar fashion, or by pressing and rolling the massage balls directly against the body with their hands.

The primary objective of the present invention is to provide an improved handheld self-administered massage device which addresses the needs which were not fulfilled by the conventional massage devices.

Another objective of the present invention is to provide a handheld self-administered massage device which can be effortlessly targeted on an intended massaging site.

Still another objective of the present invention is to provide a handheld self-administered massage device which can be implemented in a symmetrical way with a sufficient pressure for an effective self-massage.

Yet another objective of the present invention is to provide a handheld self-administered massage device which facilitates a targeted control and pressure that is ascertained by a user based on the requirements.

The summary is provided to introduce representative objectives of the invention in a simplified form that are further described below in the detailed description. This summary is not intended to identify key features or essential features of the claimed subject matter, nor is it intended to be used in any way that would limit the scope of the claimed subject matter.

### BRIEF DESCRIPTION OF DRAWINGS

Other objects, advantages and novel features of the invention will become apparent from the following detailed description of the present embodiment when taken in conjunction with the accompanying drawings. These figures are not intended to limit the scope of the present invention but rather illustrate certain attributes thereof.

FIG. 1 illustrates a schematic view of a handheld self-administered massage device in a normal state, according to an embodiment of the present invention.

FIG. 2 illustrates a schematic view of a handheld self-administered massage device of FIG. 1 in a stretched state, according to an embodiment of the present invention.

FIG. 3 illustrates a schematic view of a handheld self-administered massage device of FIG. 1 in a stretched state having a pair of first loop-style handles, according to an embodiment of the present invention.

FIG. 4 illustrates a schematic view of a handheld self-administered massage device in a normal state, according to an embodiment of the present invention.

FIG. 5 illustrates a schematic view of a handheld self-administered massage device of FIG. 4 in a stretched state, according to an embodiment of the present invention.

FIG. 6 illustrates a schematic view of a handheld self-administered massage device of FIG. 4 in an unstretched state having a pair of second loop-style handles, according to an embodiment of the present invention.

FIG. 7 illustrates a schematic view of a handheld self-administered massage device in an unstretched state having a stopper on each side of massage balls, according to an embodiment of the present invention.

FIG. 8 illustrates a schematic view of a handheld self-administered massage device of FIG. 7 having a pair of first loop-style handles, according to an embodiment of the present invention.

FIGS. 9a-9b illustrates an enlarged view of several types of loop-style handles to be attached with a handheld self-administered massage device, according to an embodiment of the present invention.

FIGS. 10a-10b illustrates a perspective view showing a person administering self-massage on his or her back by a handheld self-administered massage device, according to an embodiment of the present invention.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION OF THE INVENTION

The foregoing disclosure has broadly outlined the features and technical advantages of the present disclosure in order that the description of the disclosure that follows may be better understood. It should be appreciated by those skilled in the art that the conception and specific embodiment disclosed may be readily utilized as a basis for modifying or designing other structures for carrying out the same purposes of the present disclosure. The novel features which are believed to be characteristic of the disclosure, both as to its organization and method of operation, together with further objects and advantages will be better understood from the following description.

Before explaining the present invention in detail, it is to be understood that the invention is not limited in its application to the details of the construction and arrangement of parts illustrated in the accompanying drawings. The invention is capable of other embodiments, as depicted in different figures as described above and of being practiced or conducted in a variety of ways. It is to be understood that the phraseology and terminology employed herein is for the purpose of description and not of limitation.

It should be understood that an embodiment is an example of a possible implementation of any features and/or elements presented in the attached claims. Some embodiments have been described for the purpose of illuminating one or more of the potential ways in which the specific features and/or elements of the attached claims fulfil the requirements of uniqueness, utility and non-obviousness.

Use of the phrases and/or terms such as but not limited to “exemplary embodiment,” “an embodiment,” “an alternate embodiment,” “one embodiment,” “another embodiment,” or variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

It is to be understood that the term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

As used herein, the terms “user” and “person” are interchangeable and refer to anyone who requires a body massage.

The present invention discloses an improved handheld self-administered massage device that can be effortlessly applied on a targeted site, for instance a person's back, in a symmetrical way with a sufficient pressure to obtain an effective self-massage without taking help of another person. The handheld self-administered massage device can also be applied to various parts of a human body to obtain the effective self-massage.

Reference will now be made in detail to preferred embodiments of the present invention, an example of which is illustrated in the accompanying drawings.

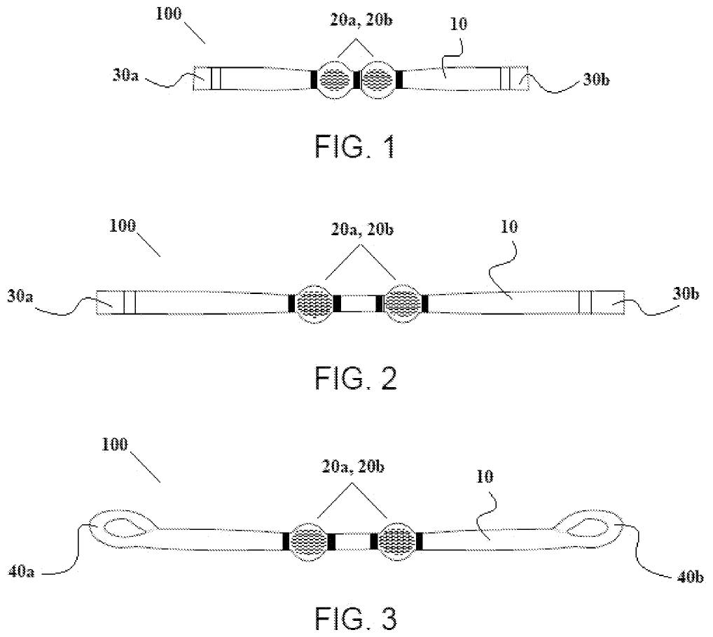

According to an exemplary embodiment of the present invention, a schematic view of a handheld self-administered massage device 100 is shown in FIG. 1. Turning to FIG. 1, the handheld self-administered massage device 100 comprising: a stretchable fabric strap 10 in the form of an elongated strip, configured to be implemented on the various body parts; a pair of massage balls 20a, 20b, configured to be encased or attached within the stretchable fabric strap 10 at a relative position in order to deliver the effective self-massage on the targeted site; and at least two gripping surfaces 30a, 30b, each provided at respective end of the stretchable fabric strap 10, adapted to allow the person to hold and manipulate the handheld self-administered massage device 100 with an utmost comfort.

In an embodiment of the present invention, the pair of massage balls 20a, 20b may collectively be referred to as the massage balls 20a, 20b, without departing from the scope of the present disclosure. Further, the massage balls 20a, 20b may individually be referred to as first massage ball 20a and second massage ball 20b.

According to one embodiment of the present invention, the massage balls 20a, 20b are held in their relative position by shape and tension of the stretchable fabric strap 10, on either side of each massage ball. The massage balls 20a, 20b may be attached with the stretchable fabric strap 10 by various sewing or tacking methods to hold the massage balls 20a, 20b in their relative positions.

Further referring to FIG. 1, the handheld self-administered massage device 100 is shown in a normal or unstretched state, wherein the massage balls 20a, 20b encased at their relative positions are shown next to one another.

In a further embodiment of the present invention, the handheld self-administered massage device 100 is shown in a stretched state in FIG. 2, wherein the handheld self-administered massage device 100 can be stretched at least two times longer of its original length. In addition, the massage balls 20a, 20b encased at their relative positions are shown stretched apart from one another due to the tension created on the stretchable fabric strap 10 on being stretched by the person while massaging.

According to another embodiment of the present invention, the handheld self-administered massage device 100 is shown in the stretched state in FIG. 3, wherein the handheld self-administered massage device 100 may comprises a pair of first loop-style handles 40a, 40b, each provided at the respective end of the stretchable fabric strap 10 or the ends of the stretchable fabric strap 10 may be affixed in a loop which may make it easier or more comfortable for the user to hold the handheld self-administered massage device 100.

According to one embodiment of the present invention, the stretchable fabric strap 10 is made up of materials selected from, but not limited to, a mix of nylon and spandex, polyester and spandex, or another fabric mixed with similar characteristics. The tension of the stretchable fabric strap 10 may vary to provide degrees of difficulty in the required strength to stretch the handheld self-administered massage device 100.

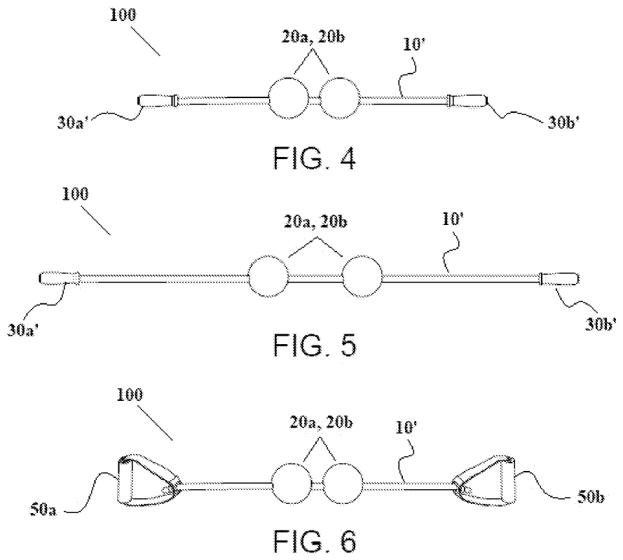

According to an alternate embodiment of the present invention, the handheld self-administered massage device 100 may employ an elastic band 10′ in place of the stretchable fabric strap 10 to encase or attach the massage balls 20a, 20b as shown in FIG. 4. The elastic band 10′ may be passed through a center of the massage balls 20a, 20b, or the elastic band 10′ may be affixed to either side of the massage balls 20a, 20b.

According to abovementioned embodiment of the present invention, when the elastic band 10′ is being passed through the center of the massage balls 20a, 20b, the snugness of the massage balls 20a, 20b around the elastic band 10′ may hold the massage balls 20a, 20b in their relative position along the elastic band 10′. However, the snugness of the fit can be loosened to allow the user to adjust the position of the massage balls 20a, 20b along the elastic band 10′ with sufficient pressure but to stay in their position during normal use.

Continue referring to FIG. 4, at least two gripping surfaces 30a′, 30b′ are shown, wherein each gripping surface is provided at respective end of the elastic band 10′, adapted to allow the person to hold and manipulate the handheld self-administered massage device 100 with the utmost comfort. Furthermore, the handheld self-administered massage device 100 with the elastic band 10′ in a normal or unstretched state is shown in FIG. 4, wherein the massage balls 20a, 20b affixed at their relative positions are shown next to one another.

In a further embodiment of the present invention, the handheld self-administered massage device 100 with the elastic band 10′ is shown in a stretched state in FIG. 5, wherein the handheld self-administered massage device 100 can be stretched at least two times longer than its original length. In addition, the massage balls 20a, 20b affixed at their relative positions are shown stretched apart from one another due to an elastic strain caused on the elastic band 10′ while stretching it.

According to one embodiment of the present invention, the handheld self-administered massage device 100 with the elastic band 10′ is shown in a normal or unstretched state in FIG. 6, wherein the handheld self-administered massage device 100 may comprises a pair of second loop-style handles 50a, 50b, each provided at the respective end of the elastic band 10′ to make it easier or more comfortable to hold.

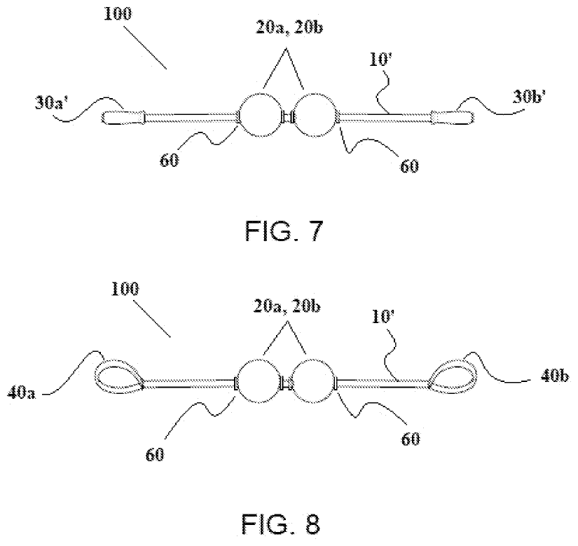

According to another embodiment of the present invention, the handheld self-administered massage device 100 with the elastic band 10′ may comprise a plurality of stoppers 60 as shown in FIGS. 7 & 8. The stoppers 60 are provided along the elastic band 10′, each located at the sides of each of the massage balls 20a, 20b, adapted to hold the massage balls 20a, 20b in their relative position along the elastic band 10′. Consequently, the snugness of the fit may be loosened further as required by the user, to allow the massage balls 20a, 20b to spin around the elastic band 10′.

According to another embodiment of the present invention, the handheld self-administered massage device 100 with the elastic band 10′ may also comprise the pair of first loop-style handles 40a, 40b as shown in FIG. 8, wherein each handle is provided at the respective end of the elastic band 10′ or the ends of the elastic band 10′ may be affixed in the loop which may make it easier or more comfortable to hold.

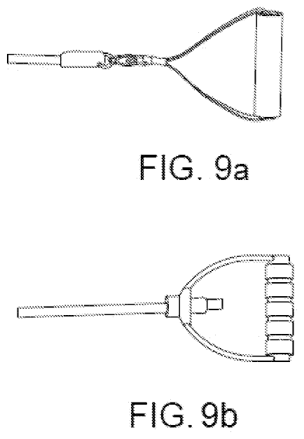

In further embodiment of the present invention, the handheld self-administered massage device 100 may employ a different type of handles as shown in FIGS. 9a & 9b. The handles may be made up of materials selected from, but not limited to, fabric, plastic, foam, or a combination of these materials.

According to an embodiment of the present invention, the massage balls 20a, 20b encased in the stretchable fabric strap 10 and/or the elastic band 10′ are made up of, but not limited to, silicone or rubber. The characteristics of the massage balls 20a, 20b may vary between the alternative embodiments of the present invention such as the size and being made of different materials. For instance, the massage balls 20a, 20b may be made up of plastic for varying levels of hardness. In addition, the massage balls 20a, 20b may be made up to have a smooth or a bumpy surface to provide different massage experiences.

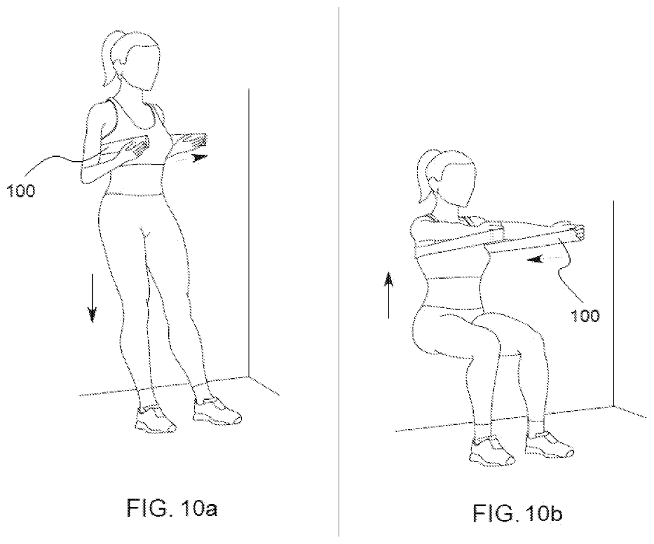

According to an embodiment of the present invention, the handheld self-administered massage device 100 being used by the user is shown in FIGS. 10a & 10b. Referring now to FIGS. 10a & 10b, the handheld self-administered massage device 100 is placed between the user and a wall while the user is holding the respective holding means of the stretchable fabric strap 10 or the elastic band 10′ as shown in FIG. 10a. However, the handheld self-administered massage device 100 can also be placed between the user and a floor.

The handheld self-administered massage device 100 utilizes the user's body weight while they lean with their back against the wall or floor to provide pressure for the self-massage. Further, the user can vary the pressure by angling their body against the wall in different ways and pushing against the floor with their feet. The user can move around the wall or floor while holding the stretchable fabric strap 10 or the elastic band 10′ to roll the massage balls 20a, 20b across or around their back. For instance, the user performs a downward motion (as shown in FIG. 10a) and an upward motion (as shown in FIG. 10b) with respect to the wall, while simultaneously pulling and releasing the stretchable fabric strap 10 or the elastic band 10′, hence, to carry out the effective self-massage on the targeted site. The combination of the pulling and releasing the stretchable fabric strap 10 or the elastic band 10′ while moving around the wall or floor allows the user to target the massage to any area of the back. Moreover, the user can apply the handheld self-administered massage device 100 on other areas of the body in a similar fashion, or by pressing and rolling the massage balls 20a, 20b directly against the body with their hands.

The improved handheld self-administered massage device of the present invention is highly beneficial and well applied as compared to the conventional self-massaging devices. The simple and unique design of the handheld self-administered massage device allows the user to deliver the effective self-massage to the various parts of the body. Also, the handheld self-administered massage device is unique in that it holds two massage balls, and it can be stretched and released to increase or decrease the distance between two massage balls. Moreover, the present invention provides targeted control and pressure which is ascertained by the user themselves based on the massaging needs. In addition, the handheld self-administered massage device of the present invention is applied on the intended site in the symmetrical way due to its flexible design. Most importantly, the present invention described herein aims to provide a solution that is practical, that can be implemented into a viable commercial success.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The invention has been explained in relation to specific embodiment. It is inferred that the foregoing description is only illustrative of the present invention, and it is not intended that the invention be limited or restrictive thereto. Many other specific embodiments of the present invention will be apparent to one skilled in the art from the foregoing disclosure. All substitution, alterations and modification of the present invention which come within the scope of the following claims are to which the present invention is readily susceptible without departing from the spirit of the invention. The scope of the invention should therefore be determined not with reference to the above description but should be determined with reference to appended claims along with full scope of equivalents to which such claims are entitled.

1. A handheld self-administered massage device, said device comprising:
a pair of massage balls, configured to be encased within a stretchable fabric strap at a relative position to deliver a self-massage to a targeted site; and
at least two gripping surfaces, each provided at respective end of said stretchable fabric strap, adapted to allow a person to hold and manipulate said device with an utmost comfort.

2. The device of claim 1, wherein said stretchable fabric strap is provided in the form of an elongated strip, configured to be implemented on various body parts.

3. The device of claim 1, wherein said massage balls are held in the relative position by shape and tension of said stretchable fabric strap, on either side of said massage balls.

4. The device of claim 1, wherein said massage balls may be encased within said stretchable fabric strap by a sewing or tacking method.

5. The device of claim 1, wherein said massage balls are made up of, but not limited to, silicone or rubber.

6. The device of claim 1, can be stretched at least two times longer than its original length.

7. The device of claim 1, further comprises a pair of first loop-style handles, each provided at the respective end of said stretchable fabric strap or the ends of said stretchable fabric strap may be affixed in a loop.

8. The device of claim 1, wherein said stretchable fabric strap is made up of materials selected from, but not limited to, a mix of nylon and spandex, polyester and spandex, or another fabric mixed with similar characteristics.

9. A handheld self-administered massage device, said device comprising:
a pair of massage balls, configured to be affixed to an elastic band at a relative position to deliver a self-massage to a targeted site; and
at least two gripping surfaces, each provided at respective end of said elastic band, adapted to allow a person to hold and manipulate said device with an utmost comfort.

10. The device of claim 9, wherein said elastic band may be passed through a center of said massage balls or said elastic band may be affixed to either side of said massage balls.

11. The device of claim 9, wherein said device can be stretched at least two times longer than its original length.

12. The device of claim 9, further comprises a pair of first loop-style handles, wherein each handle is provided at the respective end of said elastic band or the ends of said elastic band may be affixed in a loop.

13. The device of claim 9, further comprises a pair of second loop-style handles, wherein each handle is provided at the respective end of said elastic band.

14. The device of claim 9, further comprises a plurality of stoppers along said elastic band, wherein each stopper is located at sides of each of said massage balls, adapted to hold said massage balls in the relative position along said elastic band.

15. The device of claim 9, wherein said massage balls are made up of, but not limited to, silicone or rubber.
